(19) United States
(12) Patent Application Publication
(10) Pub. No.: US 2015/0209966 A1
(43) Pub. Date: Jul. 30, 2015

(54) ACTUATOR AND ARTICULATED ROBOT ARM

(71) Applicant: CANON KABUSHIKI KAISHA, Tokyo (JP)

(72) Inventor: Masahide Hasegawa, Yokohama-shi (JP)

(21) Appl. No.: 14/601,728

(22) Filed: Jan. 21, 2015

(30) Foreign Application Priority Data
Jan. 29, 2014 (JP) 2014-014567

(51) Int. Cl. B25J 18/04; F16H 1/12

(52) U.S. Cl. CPC B25J 18/04; F16H 1/12

(57) ABSTRACT

An actuator includes a housing, an output shaft arranged coaxially with the housing, and provided so as to freely rotate with respect to the housing, and a drive mechanism for rotationally driving the output shaft with respect to the housing. The drive mechanism includes a first gear, a second gear, a swing gear, a rotor magnetic circuit, and a stator magnetic circuit. The swing gear is arranged between the first gear and the second gear, and is provided so as to freely rotate about a tilting axis, which is tilted with respect to an axis of the housing. The rotor magnetic circuit is fixed to the swing gear. The stator magnetic circuit is fixed to the housing, and configured to generate an electromagnetic force of attracting or repulsing the rotor magnetic circuit, to thereby swing the swing gear.

### BACKGROUND OF THE INVENTION

1. Field of the Invention

The present invention relates to an actuator including a swing gear, and an articulated robot arm including the actuator.

2. Description of the Related Art

In general, industrial robots include an articulated robot arm using a speed reduction apparatus to convert a high-speed and low-torque output of a drive motor into a low-speed and high-torque output, to thereby drive each of joints. As the speed reduction apparatus used for the articulated robot arm, there is known a swing gear mechanism, which provides a large speed reduction ratio through swing motion of the swing gear.

As the swing gear mechanism of this type, there is proposed such a mechanism that a swing gear different in the number of teeth from a fixed gear provided coaxially with an input shaft is meshed with the fixed gear so as to be tilted by the input shaft, and that the swing gear is controlled to carry out swing motion through rotation of the input shaft (Japanese Patent Publication No. S44-2373). According to Japanese Patent Publication No. S44-2373, the speed reduction is carried out by such a configuration that the swing gear revolves (rotates) per rotation of the input shaft by an amount corresponding to a difference in the number of teeth, thereby extracting only the revolution (rotation) component onto the output shaft.

Although the usage is not for the robot, there is proposed an actuator obtained by integrating, with a motor, such a configuration that an output gear is provided on an opposite side of a fixed gear, and the output gear and the fixed gear are meshed with a swing gear so as to reduce the speed through differential motion between the two sets of gears instead of extracting a revolution component (refer to Japanese Patent No. 4,617,130).

Incidentally, a gear having a general involute tooth profile or a pin gear is used in these swing gear mechanisms, thereby being difficult to increase the number of the meshing teeth. Moreover, a tilting shaft for pivotally supporting the swing gear is required to have high precision and high rigidity in order to stabilize the meshing, which requires use of high capacity bearings and precise assembly. Therefore, there arises such a problem that these swing gear mechanisms are not suited to the actuator requiring a small size, a light weight, a high rigidity, and a high torque capacity, which is used as the joint actuator of the industrial robot.

### SUMMARY OF THE INVENTION

According to one embodiment of the present invention, there is provided an actuator, including: a first shaft; a second shaft arranged coaxially with the first shaft, and provided so as to freely rotate with respect to the first shaft; and a drive mechanism for rotationally driving the second shaft with respect to the first shaft, the drive mechanism including: a first gear including teeth directed toward one side in an axial direction, and arranged coaxially with the first shaft; a second gear including teeth opposed to the teeth of the first gear, arranged coaxially with the first shaft, and fixed to the second shaft; a first swing gear arranged between the first gear and the second gear, and provided so as to freely rotate about a tilting axis, which is tilted with respect to an axis of the first shaft, the first swing gear including: first teeth different in number by one tooth from the teeth of the first gear, and configured to mesh with the teeth of the first gear; and second teeth different in number by one tooth from the teeth of the second gear, and configured to mesh with the teeth of the second gear on an opposite side of a meshing portion of the first teeth with the teeth of the first gear in a radial direction and in the axial direction, the first swing gear being configured to mesh with the first gear and the second gear at a certain tilting angle; a rotor magnetic circuit fixed to the first swing gear; and a stator magnetic circuit fixed to the first shaft, and configured to generate an electromagnetic force of one of attracting and repulsing the rotor magnetic circuit, to thereby swing the first swing gear.

Further features of the present invention will become apparent from the following description of exemplary embodiments with reference to the attached drawings.

### BRIEF DESCRIPTION OF THE DRAWINGS

FIG. 1 is a perspective view illustrating a schematic configuration of a robot apparatus according to a first embodiment of the present invention.

FIGS. 2A, 2B, 2C, 2D and 2E are diagrams illustrating an actuator according to the first embodiment.

FIG. 3 is a diagram for acquiring a protruded tooth profile curve of a gear mechanism to be used for the actuator according to the first embodiment.

FIGS. 4A, 4B, 4C, 4D and 4E are diagrams illustrating meshing states between a tooth of a first gear and a tooth of a swing gear.

FIGS. 5A, 5B and 5C are diagrams illustrating an actuator according to a second embodiment of the present invention.

FIGS. 6A and 6B are diagrams illustrating an actuator according to a third embodiment of the present invention.

FIGS. 7A and 7B are diagrams illustrating an actuator according to a fourth embodiment of the present invention.

FIGS. 8A and 8B are diagrams illustrating an actuator according to a fifth embodiment of the present invention.

### DESCRIPTION OF THE EMBODIMENTS

Preferred embodiments of the present invention will now be described in detail in accordance with the accompanying drawings.

### First Embodiment

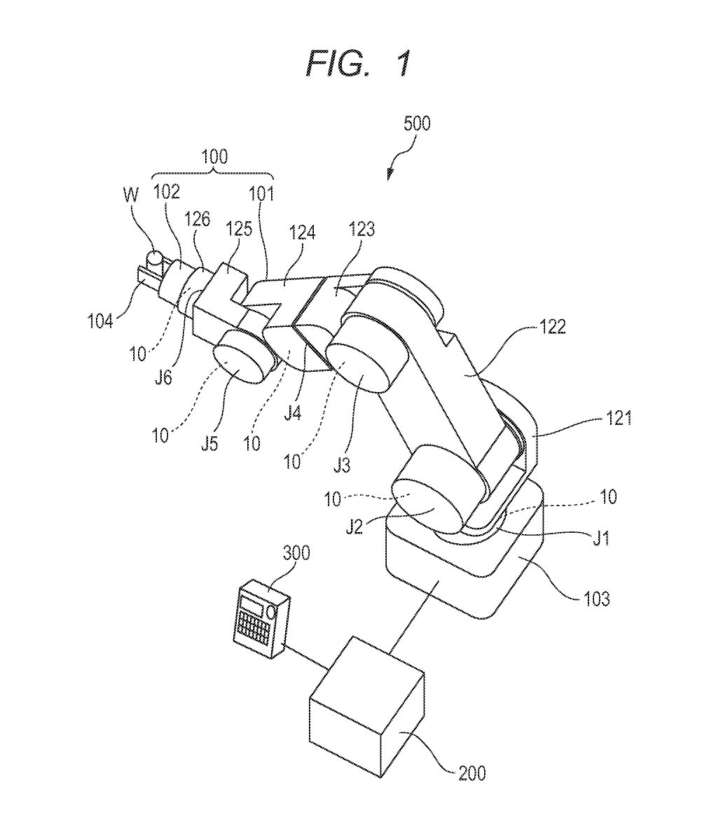

Referring to FIGS. 1 to 4E, a robot apparatus 500 according to a first embodiment of the present invention is now described. First, referring to FIG. 1, a schematic configuration of the robot apparatus 500 according to the first embodiment is described. FIG. 1 is a perspective view illustrating a schematic configuration of the robot apparatus according to the first embodiment of the present invention.

As illustrated in FIG. 1, the robot apparatus 500 includes a robot 100, which is an industrial robot for carrying out an operation such as an assembly of a workpiece W, a control device 200 for controlling the robot 100, and a teaching pendant 300 connected to the control device 200.

The robot 100 includes an articulated robot arm (hereinafter referred to as robot arm) 101, and a robot hand 102, which is an end effector connected to a distal end of the robot arm 101.

The robot arm 101 is a vertical articulated robot arm, and includes a base part 103 to be fixed to a work bench, and a plurality of links 121 to 126 for transmitting displacement and a force. The base part 103 and the plurality of links 121 to 126 are joined to each other so as to be able to turn or rotate about a plurality of joints J1 to J6. Moreover, the robot arm 101 includes, in each of the joints J1 to J6, an encoder (not shown) for detecting a rotational angle of a rotational shaft, and an actuator 10 for driving the joint. As the actuator 10 arranged in each of the joints J1 to J6, an actuator appropriate in an output depending on a magnitude of a required torque is used. Note that, the actuator 10 is later described in detail.

The robot hand 102 includes a plurality of gripping claws 104 for gripping the workpiece W, an actuator 10 for driving the plurality of gripping claws 104, an encoder (not shown) for detecting the rotational angle of the actuator 10, and a mechanism (not shown) for converting the rotation into a gripping motion. The mechanism (not shown) is a cam mechanism, a link mechanism, or the like, and is designed so as to adapt to a required gripping motion. Note that, the actuator 10 used for the robot hand 102 is different in the required torque from that for the joints of the robot arm 101, but is the same in a basic configuration. Moreover, the robot hand 102 includes a force sensor (not shown) capable of detecting stresses (reaction forces) acting on the gripping claws 104 and the like.

The teaching pendant 300 is configured to be connectable to the control device 200, and to be able to transmit commands for controlling the drives of the robot arm 101 and the robot hand 102 to the control device 200 when the teaching pendant 300 is connected to the control device 200.

The control device 200 is constructed by a computer. The computer constructing the control device 200 includes, for example, a CPU, a RAM for temporarily storing data, a ROM for storing programs for controlling respective parts, and an input/output interface circuit. The control device 200 controls supplies of required electric power required for the operations of the actuators 10 from a power supply main unit (not shown) to the actuators 10, thereby controlling positions and attitudes of the robot arm 101 and the robot hand 102.

The robot apparatus 500 configured as described above moves the robot hand 102 to an arbitrary position and attitude through the control by the control device 200 for operations of the actuators 10 in the respective joints J1 to J6 of the robot arm 101 based on input settings and the like. Then, the robot apparatus 500 controls the drives of the actuators 10 while using the force sensor to detect the stresses acting on the gripping claws 104 at the arbitrary position and attitude, thereby controlling the robot hand 102 to grip the workpiece W for an operation such as assembly of the workpiece W.

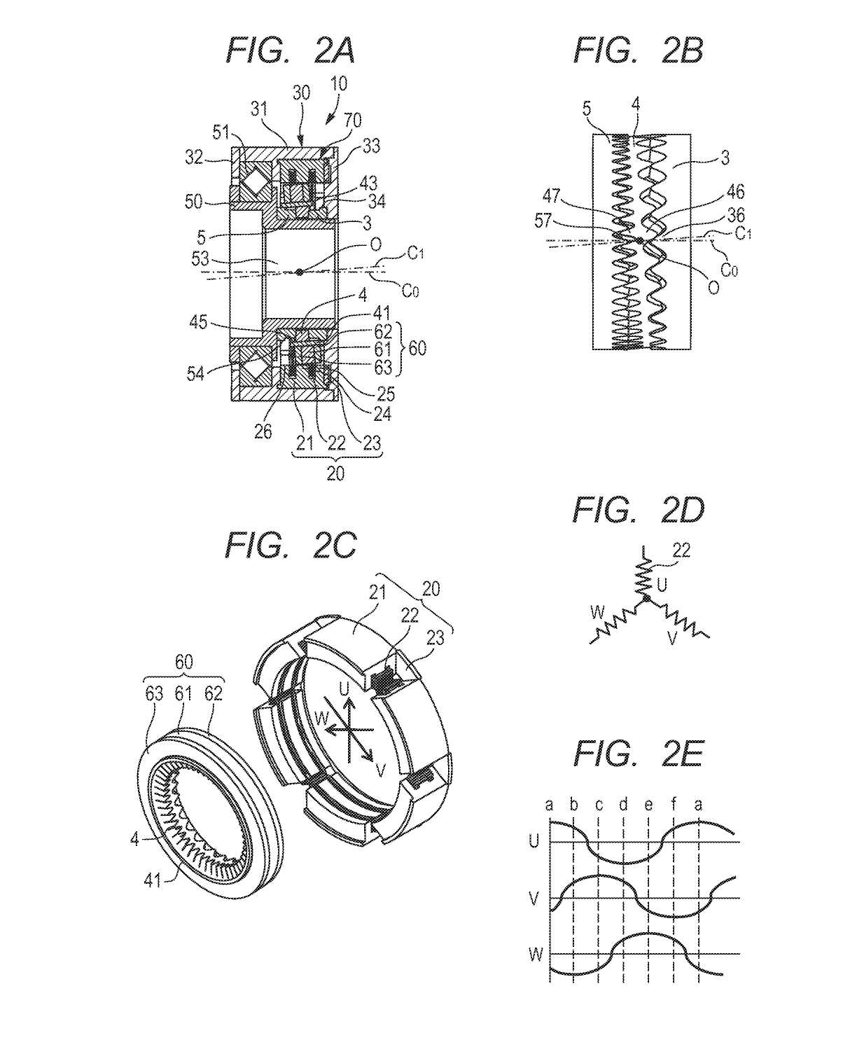

Referring to FIGS. 2A to 4E, the actuator 10 according to the first embodiment is now described. First, referring to FIGS. 2A to 2E, a schematic configuration of the actuator 10 is described. FIGS. 2A to 2E are diagrams illustrating the actuator according to the first embodiment. FIG. 2A is a cross sectional view of the actuator; FIG. 2B, a side view of gears of the actuator; FIG. 2C, an exploded perspective view of magnetic circuits of the actuator; FIG. 2D, a wiring diagram of coils of a stator magnetic circuit; and FIG. 2E, a waveform diagram of drive currents supplied to the respective coils.

As illustrated in FIG. 2A, the actuator 10 includes a housing 30, which is a first shaft, an output shaft 50, which is a second shaft, and a drive mechanism 70. The output shaft 50 is arranged coaxially with the housing 30, and is supported on the housing 30 so as to freely rotate through intermediation of a crossed roller bearing (bearing) 51. The drive mechanism 70 rotationally drives the output shaft 50 with respect to the housing 30. In other words, the output shaft 50 is relatively rotated with respect to the housing 30 through the drive of the drive mechanism 70.

In the first embodiment, the first shaft is the housing 30, and hence the drive mechanism 70 is accommodated inside the housing 30. The drive mechanism 70 is formed into an annular profile, and the output shaft 50 is arranged inside the drive mechanism 70.

Note that, one of the housing 30 and the output shaft 50 is fixed to the base part 103 (FIG. 1), and the other of the housing 30 and the output shaft 50 is fixed to the link 121 (FIG. 1). Similarly, one of the housing 30 and the output shaft 50 is fixed to one of the two links coupled to each other out of the links 121 to 126 (FIG. 1), and the other of the housing 30 and the output shaft 50 is fixed to the other of the links.

The housing 30 includes a body 31 formed into an approximately cylindrical profile, a lid part 32 in an annular profile fixed to one open end of the body 31, and a lid part 33 in an annular profile fixed to the other open end of the body 31. A hollow bore 53 is formed in the output shaft 50. An outer race of the crossed roller bearing 51 is fixed to an inner surface of the body 31 of the housing 30, and an inner race is fixed to an outer surface of the output shaft 50.

The drive mechanism 70 includes a first gear 3, a second gear 5, a swing gear 4, which is a first swing gear, a stator magnetic circuit 20, and a rotor magnetic circuit 60. The first gear 3, the second gear 5, the swing gear 4, the stator magnetic circuit 20, and the rotor magnetic circuit 60 are formed into annular profiles. The first gear 3, the second gear 5, and the stator magnetic circuit 20 are arranged coaxially with the housing 30 (output shaft 50).

The stator magnetic circuit 20 is fixed to an inside of the housing 30, specifically an inside of the body 31 of the housing 30. A flange 41 serving as a support unit for supporting the swing gear 4 is fixed to the swing gear 4, and the rotor magnetic circuit 60 is fixed to the flange 41. As a result, the rotor magnetic circuit 60 is integrally fixed to the swing gear 4 through intermediation of the flange 41. Specifically, the flange in the annular profile is fixed to the inside of the rotor magnetic circuit 60, and the swing gear 4 is fixed to the inside of the flange 41. The swing gear 4 and the rotor magnetic circuit 60 integrated with each other are arranged inside the stator magnetic circuit 20.

The first gear 3, the second gear 5, and the swing gear 4 are formed into face gears, and teeth are formed on one surface of each of the first gear 3 and the second gear 5, and on both surfaces of the swing gear 4. Then, the swing gear 4 is arranged between the first gear 3 and the second gear 5.

In more detail, as illustrated in FIG. 2B, the first gear 3 includes teeth 36 formed on the one surface, and directed toward one side in the axial direction. The number of the teeth 36 is Z1. The teeth 36 include a plurality of tooth tip parts formed on a distal end side with respect to a predetermined height and a plurality of recessed parts each formed between the tooth tip parts on a tooth base side with respect to the predetermined height, and are formed into an annular profile. The first gear 3 is fixed to any one of the housing 30 and the output shaft 50, and, according to the first embodiment, as illustrated in FIG. 2A, is fixed to the housing 30. Specifically, the first gear 3 is fixed to an inside of the housing 30, which is the lid part 33 of the housing 30.

As illustrated in FIG. 2B, the second gear 5 includes teeth 57 formed on a surface on a side opposed to the first gear 3. The number of the teeth 57 is Z2. The teeth 57 include a plurality of tooth tip parts formed on a distal end side with respect to a predetermined height and a plurality of recessed parts each formed between the tooth tip parts on a tooth base side with respect to the predetermined height, and are formed into an annular profile. The second gear 5 is fixed to the output shaft 50, specifically to the outside of the output shaft 50.

The swing gear 4 is arranged between the first gear 3 and the second gear 5, and is provided so as to freely rotate about a tilting axis C₁ tilted with respect to an axis C₀ of the housing 30 (output shaft 50). The swing gear 4 includes, on one surface, first teeth 46 having a tooth surface formed into an annular profile, for meshing with the teeth 36 of the first gear 3, and, on the other surface, second teeth 47 having a tooth surface formed into an annular profile, for meshing with the teeth 57 of the second gear 5.

The number of the first teeth 46 is Z1+1 (different by one from the number of teeth of the first gear 3). The number of the second teeth 47 is Z2+1 (different by one from the number of teeth of the second gear 5). The second teeth 47 are configured to mesh with the second gear 5 on a side opposite to a meshing portion of the first teeth 46 with the teeth 36 of the first gear 3 in the radial direction and the axial direction. As a result, the swing gear 4 is configured to mesh with the first gear 3 and the second gear 5 at a certain tilting angle. The swing gear 4 includes tooth tip parts formed on a distal end side with respect to a predetermined height, recessed parts each formed between the tooth tip parts on a tooth base side with respect to the predetermined height, which are larger in number than the first gear 3 and the second gear 5, and the tooth surfaces formed into the annular profiles.

In other words, the teeth 36 of the first gear 3 and the teeth 46 on one side of the swing gear 4 are arranged in a state tilted by a predetermined angle so as to be able to form a most deeply meshing position at which the tooth tip part and the recessed part most deeply mesh with each other, and a passing-by position which is on an opposite side to the most deeply meshing position, and at which the teeth tip parts pass by each other. Further, the teeth 36 of the first gear 3 and the teeth 46 of the swing gear 4 are arranged to be tilted at the predetermined angle so as to be able to form, on both sides of the passing-by position, first meshing areas where the tooth tip parts are brought into contact with each other and second meshing areas where the tooth tip part and the recessed part are brought into contact with each other on a side closer to the most deeply meshing position than the first meshing areas.

Similarly, the teeth 57 of the second gear 5 and the teeth 47 on the other side of the swing gear 4 are arranged in a state tilted by a predetermined angle so as to be able to form a most deeply meshing position at which the tooth tip part and the recessed part most deeply mesh with each other, and a passing-by position which is on an opposite side to the most deeply meshing position, and at which the teeth tip parts pass by each other. Further, the teeth 57 of the second gear 5 and the teeth 47 of the swing gear 4 are arranged to be tilted at the predetermined angle so as to be able to form, on both sides of the passing-by position, first meshing areas where the tooth tip parts are brought into contact with each other and second meshing areas where the tooth tip part and the recessed part are brought into contact with each other on a side closer to the most deeply meshing position than the first meshing areas.

Specifically, the teeth 36 of the first gear 3 and the teeth 46 of the swing gear 4 are arranged so as to shift in phase from each other by half a pitch. At a reference phase (most deeply meshing position) on the lower side of the drawing sheet of FIG. 2B, the tooth 36 of the first gear 3 and the tooth 46 of the swing gear 4 shift in phase from each other by half a pitch, and deeply mesh with each other. Moreover, in the vicinity of positions of ±90 degrees with respect to the reference phase, which are on the front side of FIG. 2B (positions at boundaries between the first meshing areas and the second meshing areas), the tooth 36 of the first gear 3 and the tooth 46 of the swing gear 4 shift in phase from each other by ¼ pitch, and shallowly mesh with each other (for example, the tooth tip parts are in contact with each other at a single point).

Further, at positions of ±180 degrees (passing-by position) with respect to the reference phase, which are on the upper side of the drawing sheet of FIG. 2B, the tooth 36 of the first gear 3 and the tooth 46 of the swing gear 4 are in the same phase, and the distal ends of the tooth tip parts are in contact with each other. Then, the teeth 36 and the teeth 46 are configured to gradually change the phase to change the meshing depth, resulting in contacts between the teeth 36 of the first gear 3 and the teeth 46 of the swing gear 4 over substantially the entire circumference between these phases. Similarly, regarding the teeth 57 of the second gear 5 and the teeth 47 of the swing gear 4, which are different in the number, the teeth 57 and the teeth 47 are configured to gradually change the phase to change the meshing depth, resulting in contacts between the teeth 57 of the second gear 5 and the teeth 47 of the swing gear 4 over substantially the entire circumference.

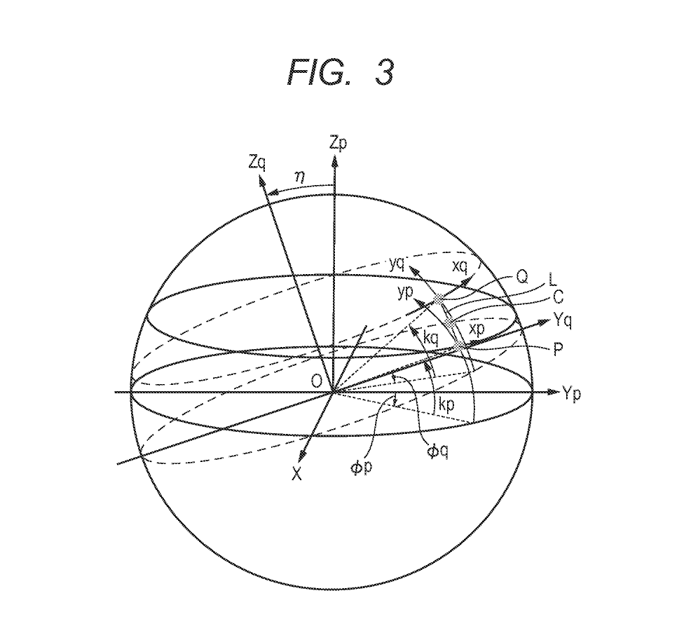

Referring to FIG. 3, such a principle that the teeth 36 of the first gear 3 and the teeth 46 of the swing gear 4 on the mating side are in contact with each other over substantially the entire circumference of the gears, and the teeth 57 of the second gear 5 and the teeth 47 of the swing gear 4 are in contact with each other over substantially the entire circumference of the gears is now described. FIG. 3 is a diagram for acquiring a protruded tooth profile curve of a gear mechanism used for the actuator 10 according to the first embodiment of the present invention.

As illustrated in FIG. 3, the center axis C₀ of the first gear 3 is denoted by Zp axis; the tilting axis C₁ of the swing gear 4, Zq axis; a tilting angle of the Zq axis with respect to the Zp axis, η; and a common axis in a direction orthogonal to a plane containing the Zp axis and the Zq axis, X axis. Note that, a reference point O is an origin of the Zp axis and the Zq axis. Then, an XYpZp coordinate system and an XYqZq coordinate system are set. A spherical surface having the origin O as the center and a radius R is now considered.

Points P and Q (each referred to as reference point of teeth) moving clockwise at constant speeds from the Yp axis direction and the Yq axis direction on small circles (referred to as reference pitch circles) at latitude offsets kp and kq with respect to an XYp plane and an XYq plane, which are equatorial planes of the respective coordinate systems, are considered. If the number of teeth of the first gear 3 is Z1, and the number of teeth of the swing gear 4 is Z1+1, latitudes of the points P and Q are represented as φp=2nt/Z1 and φp=2nt/(Z1+1) (t: parameter).

On this occasion, a point C on an arc L of a great circle connecting the points P and Q with each other is set to a meshing point, and trajectories of the point C in moving coordinate systems xpyp and xqyq on spheres having the points P and Q as origins are to be acquired. The trajectories can be used as protruded profiles of the tooth tip parts, thereby bringing the tooth tips successively in contact with each other in a range of approximately ±90° from the passing-by phase. The trajectory is a curve close to the COS function, but is complex and cannot be represented by a simple equation. The trajectory is thus not described, but the coordinate of the point C only needs to be acquired, to thereby acquire differences from the coordinates of the points P and Q.

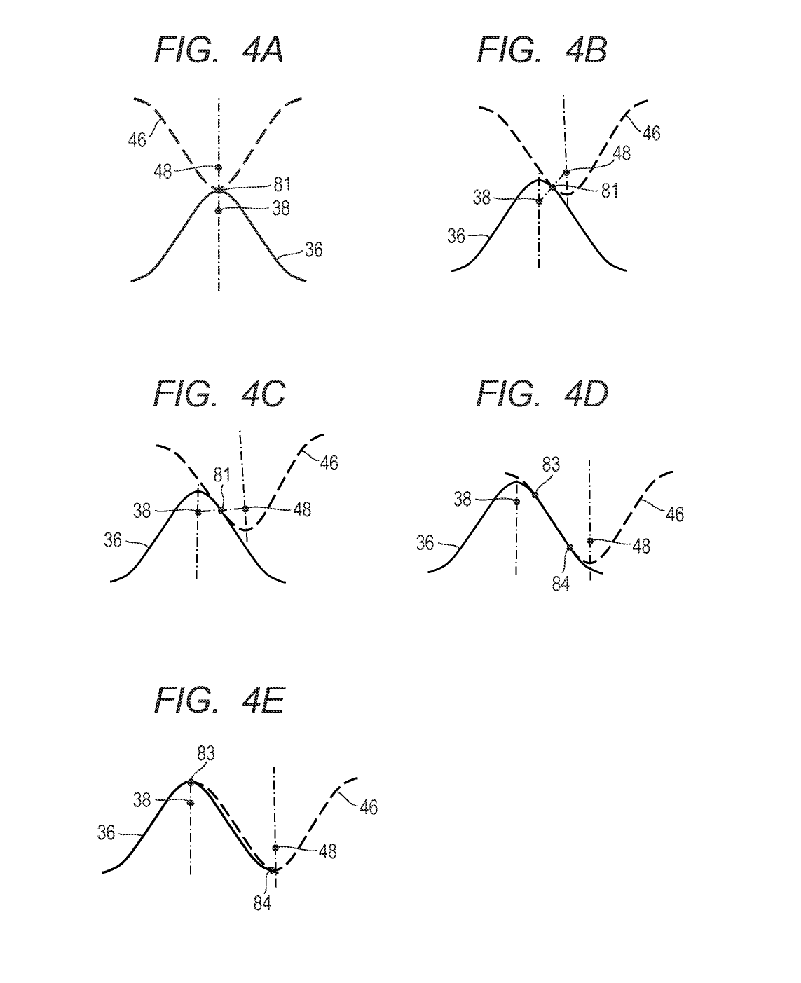

Referring to FIGS. 4A to 4E, such a principle that the tooth tip parts of the teeth 36 of the first gear 3 and the recessed parts of the teeth 46 of the swing gear are brought into contact with each other, and the recessed parts of the teeth 36 of the first gear 3 and the tooth tip parts of the teeth 46 of the swing gear 4 are brought into contact with each other is now described. FIGS. 4A to 4E are diagrams illustrating meshing states of the tooth 36 of the first gear 3 and the tooth 46 of the swing gear 4.

When the teeth 36 and 46 of the tooth tip parts of the first gear 3 and the swing gear 4 are formed as described before, as illustrated in FIG. 4A, at the phase (passing-by position) in the Yp and Yq directions, the distal ends of the tooth tip parts at predetermined heights from reference points (predetermined heights) 38 and 48 are brought into contact with each other at a meshing point 81. Then, as the position turns toward the X axis direction on the both sides of the passing-by position, as illustrated in FIGS. 4B and 4C, the meshing point 81 transitions in the first meshing areas (the tooth tip parts are in contact with each other at a single point). Although a profile of the tooth tip part formed up to a vicinity of the boundary position in the X axis direction is a protruded profile, interference occurs if the recessed part on the tooth base side with respect to the protruded profile is formed into a tooth profile based on the trajectory of the point C described above. Thus, in the first embodiment, the meshing point 81 in the vicinity of the boundary position is considered as a meshing reference point (reference position). Then, the tooth profile curve of the recessed part on the tooth base side with respect to the meshing reference point is formed as a curve acquired as a circumscribed line (recessed profile aligned with a passed area) of such a trajectory that the tooth tip part on the distal end side with respect to the meshing reference point moves at the tooth base part of the mating tooth.

Therefore, as illustrated in FIGS. 4D and 4E, the tooth tip part of the tooth and the recessed part of the mating tooth mesh with each other in the second meshing area, and meshing thus occurs simultaneously at two points represented by contact points 83 and 84.

The first gear 3 and the swing gear 4 of the gear mechanism according to the first embodiment are thus brought into contact with each other over substantially the entire circumference in this way. A transmitted torque is thus shared, and an extremely large load capacity can be provided by the compact and light-weight gear mechanism. Moreover, the pressure angle decreases as the number of teeth Z increases and as the tilting angle η increases, and an appropriate pressure angle can thus be set. Further, as illustrated in FIGS. 4A to 4E, a curve of the tooth profile before and after the meshing reference point is close to a straight line. Particularly, the tooth tip part and the recessed part mesh with each other at two points and between the protruded surface and the recessed surface at a phase at which the meshing is deeper than the meshing reference point. Therefore, the contact pressure is reduced. Thus, the tooth profile is small in tooth surface stress, and is less worn.

Note that, the teeth 57 of the second gear 5 and the teeth 47 of the swing gear 4 are different only in the number of teeth, and the same principle applies thereto. A description thereof is therefore omitted.

The teeth 36 of the first gear 3, the teeth 46 of the swing gear 4, the teeth 57 of the second gear 5, and the teeth 47 of the swing gear 4 are formed into such a tooth profile as to come in contact with each other over substantially the entire circumference in this way. Thus, out of degrees of freedom in the attitude of the swing gear 4, degrees of freedom other than the tilting direction are regulated by the meshing between the teeth. In other words, the position is regulated by the shared reference point O, and the tilting angle of the axis C₁ and the rotational phase about the axis C₁ are regulated by the meshing between the teeth.

Further, according to the first embodiment, reception surfaces 43 and 45 in the circumferential direction, which are brought into contact with the first gear 3 and the second gear 5 in the radial direction, are provided on the flange 41 so as to further ensure the meshing between the first gear 3 and the swing gear 4, and the meshing between the second gear 5 and the swing gear 4. In other words, a cylindrical surface 34 to come in contact with the inner conical surface 43 provided on the flange 41 is provided on the first gear 3, and a cylindrical surface to come in contact with the inner conical surface 45 provided on the flange 41 is provided on the second gear 5.

The surfaces 34 and 43 and the surfaces 54 and 45 are respectively contact surfaces in profiles that can come in contact with each other only at the lower and upper phases in FIG. 2A, and a ratio between the radii of the contact surfaces with respect to the axis C₀ and the tilting axis C₁ is equal to a ratio of reciprocals of the numbers of teeth. These reception surface parts (contact surfaces) have minute gaps, and do not come in contact with each other without a load. When a load acts to generate minute distortions on the gears 3, 4, and 5, the contact is generated to prevent a change in the attitude of the swing gear 4. On this occasion, referring to FIGS. 2A and 2B, resultant forces of forces acting on the surfaces 34 and 43 and forces acting on tooth surfaces of the first gear 3 and the swing gear 4 are opposite directions and thus cancel each other in an up/down direction, resulting in a force pushing the swing gear 4 toward the left direction. On the other hand, resultant forces of forces acting on the surfaces 54 and 45 and forces acting on tooth surfaces of the first gear 3 and the swing gear 4 similarly result in a force pushing the swing gear 4 toward the right direction. Thus, an axial load is generated on the crossed roller bearing 51, but the load caused by a moment force can be suppressed to be small. Therefore, the attitudes of the gears 3, 4, and 5 are prevented from changing, and a vibration does not become large. Moreover, as described before, the ratio between the radii of the contact surfaces to the axes C₀ and C₁ is set to the ratio between reciprocals of the numbers of teeth, and the momentary tangential velocities of the contact surfaces are thus equal to each other, which represents a rolling contact state. As a result, a configuration capable of suppressing an increase in a lost torque and the wear to minimum is provided.

Incidentally, the tilting direction of the swing gear 4 is not regulated by the meshing of the teeth, but is regulated by an electromagnetic force exerted by the stator magnetic circuit 20 on the rotor magnetic circuit 60. As illustrated in FIGS. 2A and 2C, the stator magnetic circuit 20 includes stator yokes 21 each made of a soft magnetic material such as an electromagnetic steel sheet and having an E-shape in a cross section, and coils 22 wound on slot parts of the stator yokes 21. The stator yoke 21 includes two salient poles 25 and 26 protruded to the inside in the radial direction toward the axis C₀, and a center salient pole 24 formed between the two salient poles 25 and 26, and protruded to the inside in the radial direction. The stator magnetic circuit 20 is constructed by arranging six cores each constructed by the stator yoke 21 and the coil 22 on a circumference, and the coils 22 are connected to each other on a board 23. The board 23 is connected to a drive circuit via terminals (not shown).

The rotor magnetic circuit 60 includes an annular permanent magnet 61 magnetized in the direction of the tilting axis C₁, and rotor yokes 62 and 63 made of a soft magnetic material and provided on both end surfaces of the permanent magnet 61. The rotor magnetic circuit 60 is arranged so that an outer peripheral surface of the rotor magnetic circuit 60, namely, an outer peripheral surface of the permanent magnet 61 is opposed to the stator magnetic circuit 20 in the radial direction. In FIG. 2A, at the lower phase, a magnetic flux generated by the N pole of the permanent magnet 61 passes through the rotor yoke 62, enters the stator yoke 21 from the opposing salient pole 25, exits from the center salient pole 24, passes through the opposing rotor yoke 63, and returns to the S pole of the permanent magnet 61. In FIG. 2A, at the upper phase, conversely, the magnetic flux enters the center salient pole 24 from the rotor yoke 62, and returns from the salient pole 26 to the rotor yoke 63. At an intermediate phase, an intermediate flux distribution therebetween is brought about. Note that, a non-magnetic material such as aluminum or brass only needs to be used for the flange 41 so as not to influence the rotor magnetic circuit 60.

Referring to FIGS. 2C to 2E, wiring and a drive method for the coils 22 of the stator magnetic circuit 20 are now described. In FIG. 2C, the six coils 22 are wired so that two coils at positions opposed to each other at 180 degrees are paired, and are respectively magnetized in opposite directions by a drive current. Thus, the six coils 22 are divided into three groups for a U phase, a V phase, and a W phase. As illustrated in FIG. 2D, the coils 22 in these three phases are wired in a Y-shape, and drive currents as illustrated in FIG. 2E are supplied.

In FIG. 2E, a horizontal axis represents time, and a vertical axis represents the currents in the respective phases. At a time point “a”, the maximum current flows in the U phase toward the positive direction, and is divided into currents that flow in the V and W phases toward the negative direction. The respective phases are driven so that the currents in the respective phases change as sinusoidal waveforms in a sequence of time points “b”, “c”, and “d”. In FIG. 2C, the upper and lower coils 22 are considered as those in the U phase, the coils 22 in a direction shifted by 120 degrees clockwise viewed from the left are considered as those in the V phase, and the rest are considered as those in the W phase. FIG. 2C illustrates, by arrows, directions in each of which the center salient pole 24 is excited by a current toward the positive direction.

For example, at the time point “a”, a magnetic flux maximum in the strength is generated in the U phase in the upward direction, and magnetic fluxes 50% in the strength are generated in the V and W phases in obliquely upward directions, which are opposite to the arrows in the illustration. Thus, the center salient poles 24 of the three stator yokes 21 on an upper side of the drawing sheet are excited to form S poles, and the center salient poles of the three stator yokes 21 on a lower side of the drawing sheet are excited to form N poles.

As a result, at the upper position, attractive forces act on the rotor yoke 62 from the center salient poles 24, and repulsive forces act on the rotor yoke 62 from the salient poles 25. Moreover, at the lower position, attractive forces act on the rotor yoke 62 from the salient poles 25, and repulsive forces act on the rotor yoke 62 from the center salient poles 24. Moreover, on the rotor yoke 63, at the upper position, attractive forces act from the salient poles 26, and repulsive forces act from the center salient poles 24, and, at the lower position, attractive forces act from the center salient poles 24, and repulsive forces act from the salient poles 26. Thus, resultant forces of these forces form the moment force of tilting the rotor magnetic circuit 60 in the direction illustrated in FIG. 2A.

Then, at the time point “b”, the magnetic flux having a maximum intensity is generated in the W phase in an obliquely upward direction, the magnetic flux having an intensity of 50% is generated in the U phase in the upward direction, and the magnetic flux having an intensity of 50% is generated in the V phase in an obliquely downward direction. Thus, the moment force acting on the rotor magnetic circuit 60 rotates by 60 degrees clockwise as viewed from the left side of the drawing sheet, and further rotates by 60 degrees at each of the time points c, d, e, and f. In this way, the direction of the moment force acting on the rotor magnetic circuit 60 can be smoothly and continuously rotated through the drive using the currents in the three phases illustrated in FIG. 2E.

As described above, the swing gear 4 integrated with the rotor magnetic circuit 60 is regulated in the position and the tilting angle by the two gears 3 and 5. When the direction of the moment force rotates in this way, the swing gear 4 thus swings while the tilting direction rotates in accordance with the rotation of the direction of the moment force.

Referring to FIGS. 2A and 2C, an operation of the actuator 10 is now described. As described above, when the direction of the moment force acting on the rotor magnetic circuit 60 is rotated with the three-phase drive currents, the swing gear 4 once carries out the swing motion about the reference point O, which is an intersection between the tilting axis C₁ and the axis C₀.

On this occasion, the swing gear 4 rotates (revolves) by an angle corresponding to the difference in the number of teeth between the first gear 3 and the swing gear 4. In other words, when the direction of the moment force rotates by (Z1+1) turns, the swing gear 4 (tilting axis C₁) revolves by one turn. On the other hand, a revolution is generated through the swing between the second gear 5 and the swing gear 4. In other words, this configuration is such a configuration as to extract the revolution of the swing gear 4 on the second differential gear mechanism. It is known that the speed reduction ratio of this differential gear mechanism can be calculated as 1−(Z1(Z2+1))/((Z1+1)Z2). For example, when Z1=24 and Z2=48, a speed reduction ratio of 1/50 is provided. Moreover, for example, when Z1=48 and Z2=49, a large speed reduction ratio of 1/2, 401 can be provided. This actuator 10 can thus realize a wide range of the speed reduction ratio starting from a small speed reduction ratio of approximately 1/20 to a large speed reduction ratio of one few thousandths.

On this occasion, the moment force of generating the swing motion of the swing gear 4 generates an extremely large rotational torque, which is increased in accordance with the speed reduction ratio, on the second gear 5. In other words, in FIG. 2B, when the moment force is applied from the magnetic circuit to tilt the swing gear 4 in such a direction as to most deeply mesh with the first gear 3 at the near side of the drawing sheet, there is generated such a force that the teeth 46 push the teeth 36 rightward to revolute the swing gear 4 upward. On the other hand, due to these forces, the teeth 47 tend to disengage rightward from the teeth 57 while pushing the teeth 57 upward, and the force is increased by the reciprocal fold of the speed reduction ratio.

In other words, it is possible to realize the actuator 10 that provides a low-speed high output torque from the rotation of the high-speed and low-torque moment force generated by the stator magnetic circuit 20 and the rotor magnetic circuit 60. Moreover, the torque is shared among the large number of teeth across substantially 180 degrees, and hence the diameter can be reduced compared with a general combination of a motor and a speed reduction mechanism. Further, it is possible to realize a small-size, lightweight, low-cost, and powerful actuator with a small number of components such as shafts and bearings. Moreover, an input shaft is absent, and hence the large hollow bore 53 can be formed in the output shaft 50, with the result that wiring and piping for the air can be routed therethrough when the actuator is used for the joints J1 to J6 of the robot arm 101.

Note that, when a load torque is applied to the output shaft 50, a phase difference is generated between the direction of the moment force generated by the drive currents and the tilting direction of the swing gear 4 as in the general brushless motor and the like. The phase difference becomes the maximum at 90 degrees, and hence an efficient three-phase drive can be carried out by using a sensor (not shown) for detecting the tilting direction, such as a Hall effect sensor and a capacitive sensor. For example, three Hall effect sensors only need to be arranged at an interval of 120 degrees in phase, to thereby detect the tilting direction of the rotor magnetic circuit 60. Moreover, the tilting direction may be detected from the inductances of the coils 22 and the counter electromotive voltage as in the so-called sensorless drive circuit.

In the actuator 10 according to the first embodiment, the first gear 3 and the second gear 5 regulate the tilting angle and the axial position of the swing gear 4, and the stator magnetic circuit 20 and the rotor magnetic circuit 60 regulate the tilting direction thereof.

Therefore, an input shaft, bearings for supporting the input shaft, and the like do not need to be provided, resulting in a reduction in the number of components. Moreover, the load torque can be shared among the large number of teeth, and hence an ease of assembly, a load capacity, and rigidity can be increased, and a loss can be reduced without increasing the size.

Moreover, in the actuator 10 according to the first embodiment, the flange 41 supporting the swing gear 4 is in contact with the first gear 3 and the second gear 5, to thereby support the swing gear 4 in the radial direction of the first gear 3 and the second gear 5. As a result, a bearing load is reduced particularly during a high load torque, and hence the load capacity and the rigidity can be further increased.

Moreover, in the actuator 10 according to the first embodiment, the contact surface between the flange 41 and each of the gears 3 and 5 is formed into such a profile that the contact occurs at a portion without relative speed, that is, into such a profile that the flange 41 is in rolling contact with each of the gears 3 and 5. As a result, the load capacity and the rigidity can be further increased compared with a case of the sliding contact.

Note that, the tooth profile described in the first embodiment, in which the contact occurs over substantially the entire circumference, is an example, and the tooth profile is not limited to this example. For example, in order to separate a vicinity of the passing-by position that does not contribute to the torque transmission due to a large pressure angle and a vicinity of the most deeply meshing position, the distal end part of the tooth tip and the most recessed part of the tooth base may be ground off. Alternatively, the distal end part of one tooth is formed into an arc having a constant radius, and a curve acquired as a circumscribed line (profile conforming to a passed area) of a trajectory of the distal end part moving around the mating tooth is set as the profile of the mating tooth. Then, a curve acquired as a circumscribed line of a trajectory of the distal end part of the mating tooth having the acquired profile, which moves around the tooth in the arc profile, may be set as the profile of the tooth having the distal end part in the arc profile. In order to regulate the position and the tilting angle of the swing gear 4 by using the two gears 3 and 5, it is only necessary to employ such a tooth profile that a plurality of the teeth always mesh with each other between ±90 degree directions about the vicinity of the most deeply meshing position.

Moreover, the example of the drive waveforms of the three-phase sinusoidal waves is described in the first embodiment, but three-phase step drive may be employed. In particular, as described above, a large speed reduction ratio of, for example, 1/2,401 can be realized by using teeth as small as approximately 50 teeth, and a high resolution motor of 14, 406 steps per turn can be easily realized.

### Second Embodiment

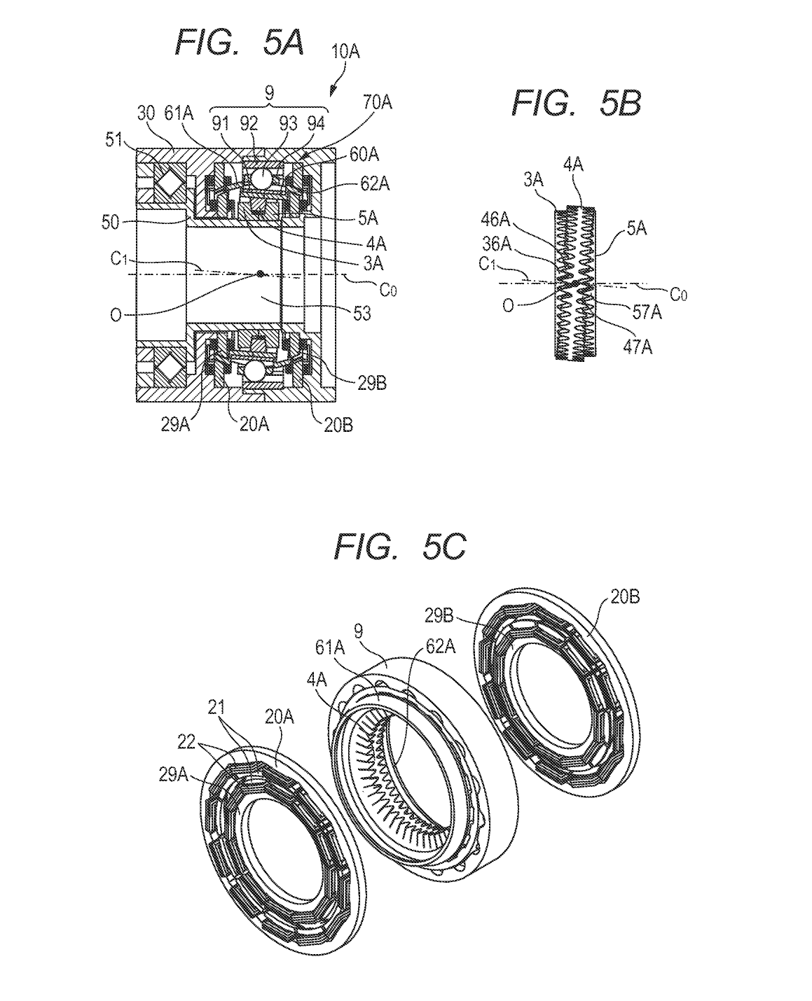

Referring to FIGS. 5A to 5C as well as FIG. 1, a robot apparatus according to a second embodiment of the present invention is now described. FIGS. 5A to 5C are diagrams illustrating an actuator according to the second embodiment. In the robot apparatus according to the second embodiment, an actuator 10A is different from the actuator 10 according to the first embodiment. Therefore, in the second embodiment, the point different from the first embodiment, namely, the actuator 10A is mainly described, and the same components as those of the first embodiment are denoted by the same reference symbols to omit a description thereof.

FIG. 5A is a cross sectional view of the actuator 10A, FIG. 5B is a side view of gears of the actuator 10A, and FIG. 5C is an exploded perspective view of magnetic circuits of the actuator 10A. As illustrated in FIGS. 5A and 5B, substantially similarly to the first embodiment, the actuator 10A includes the housing (first shaft) 30, and the output shaft (second shaft) 50 supported so as to freely rotate with respect to the housing 30 through intermediation of the crossed roller bearing 51. The output shaft 50 is arranged coaxially with the housing 30. Moreover, the actuator 10A includes a drive mechanism 70A different in configuration from that of the first embodiment. The drive mechanism 70A rotationally drives the output shaft 50 with respect to the housing 30. In other words, the output shaft 50 is relatively rotated with respect to the housing 30 through the drive of the drive mechanism 70A.

In the second embodiment, the first shaft is the housing 30, and hence the drive mechanism 70A is accommodated inside the housing 30. The drive mechanism 70A is formed into an annular profile, and the output shaft 50 is arranged inside the drive mechanism 70A.

The drive mechanism 70A includes a first gear 3A, a second gear 5A, and a swing gear 4A, which is the first swing gear. These gears 3A and 5A are arranged coaxially with the housing 30. The first gear 3A and the second gear 5A are fixed to the outside of the output shaft 50. The first gear 3A and the second gear 5A are face gears including the same number Z2 of teeth on one surface, and the swing gear 4A is a face gear including Z2+1 teeth on both surfaces. The swing gear 4A is tilted by a predetermined angle so that each of the first gear 3A and the second gear 5A and the swing gear 4A mesh with each other.

A tooth profile configured so that a large number of teeth are simultaneously in contact with each other is used also in the second embodiment, and the tilting angle and the axial position of the swing gear 4A are regulated by sandwiching the swing gear 4A between the first gear 3A and the second gear 5A. Then, a flange (rotor magnetic circuit) 60A made of a soft magnetic material is provided on the swing gear 4A, and a constant velocity joint (joint mechanism) 9 for coupling the housing 30 and the swing gear 4A to each other is provided between the housing 30 and the flange 60A.

The flange 60A is fixed to the swing gear 4A. The flange 60A includes a pair of protruded pieces 61A and 62A protruded from the swing gear 4A toward both sides in the direction of the tilting axis C₁.

According to the second embodiment, two radially outer side stator magnetic circuits 20A and 20B and two radially inner side stator magnetic circuits 29A and 29B are fixed coaxially with the housing 30 as the stator magnetic circuit.

The radially outer side stator magnetic circuit 20A and the radially inner side stator magnetic circuit 29A are arranged with an interval therebetween so as to be opposed to each other in the radial direction. Moreover, the radially outer side stator magnetic circuit 20B and the radially inner side stator magnetic circuit 29B are arranged with an interval therebetween so as to be opposed to each other in the radial direction.

Although various types of the constant velocity joint 9 exist, the constant velocity joint 9 may have, for example, the same configuration as that to be used for a drive shaft of an automobile to provide high constant velocity property and transmission efficiency. According to the second embodiment, the constant velocity joint 9 includes an inner race 91, an outer race 92, a retainer 94 supported by spherical surfaces on the inner race 91, and balls 93, and is constructed by providing straight race surfaces on the inner race 91 and the outer race 92. The constant velocity joint 9 is variable in the axial position with respect to the outer race 92. As long as the inner race 91 and the swing gear 4A are aligned to each other in the axial position, adjustment of an alignment in the axial position between the housing 30 and the output shaft 50 is not necessary for assembly. Thus, the load on the crossed roller bearing 51 during the operation can be conveniently eliminated. Note that, the constant velocity joint 9 may be such a type that both the outer race and the inner race are fixed in the axial position, and may be used after adjustment and assembly.

Referring to FIGS. 5A and 5B, an operation of the actuator 10A according to the second embodiment is now described. The stator magnetic circuits 20A, 20B, 29A, and 29B apply attractive forces, which are caused by electromagnetic forces, on parts in a circumferential direction of the pair of the protruded pieces 61A and 62A of the flange 60A for attraction. As a result, the flange 60A, which is the rotor magnetic circuit, receives a moment force about the reference point O, which is an intersection between the tilting axis C₁ and the axis C₀, with the electromagnetic forces from the radially outer side stator magnetic circuits 20A and 20B and the radially inner side stator magnetic circuits 29A and 29B. When the tilting direction rotates about the axis C₁ by the moment force, the swing gear 4A is regulated in the revolution by the constant velocity joint 9, and thus swings in situ without rotation. During one swing motion, the first gear 3A and the second gear 5A are rotated by an angle corresponding to a difference in the number of teeth between each of the first gear 3A and the second gear 5A and the swing gear 4A, to thereby rotate the output shaft 50. In other words, this configuration is a configuration of a single-stage differential gear mechanism. The speed reduction ratio of this differential gear mechanism can be calculated as −1/Z2. For example, when Z2=48, a speed reduction ratio of −1/48 can be provided.

Forces acting on respective parts due to the load torque on the actuator 10A according to the second embodiment are now described. In FIGS. 5A and 5B, when a clockwise load torque as viewed from the left side of the drawing sheet acts on the output shaft 50, teeth 57A of the second gear 5A push teeth 47A of the swing gear 4A toward a lower left direction at a phase at the near side in the drawing sheet. This downward force is regulated by the constant velocity joint 9. On the other hand, teeth 36A of the first gear 3A push teeth 46A of the swing gear 4A toward an upper right direction at a phase at a far side in the drawing sheet. This upward force is similarly regulated by the constant velocity joint 9. As a result, the swing gear 4A receives only the moment force in the clockwise direction about the reference point O as viewed from above, and tends to rotate the tilting direction counterclockwise as viewed from the left of the drawing sheet. In other words, components of the forces acting on the swing gear 4A other than the components of rotating the tilting direction are canceled, and forces in the axial direction or eccentric direction do not act. Thus, only the moment force of rotating the tilting direction clockwise is generated, and balances with the electromagnetic force. Thus, the forces applied to the crossed roller bearing 51 can also be suppressed to be small, thereby being capable of realizing high efficiency, low vibration, and low noise.

Note that, the configuration to regulate the revolution of the swing gear 4A is not limited to the configuration using the balls 93, and a joint mechanism having a different configuration, such as a so-called gimbal mechanism or a spring coupling, may be used.

Referring to FIGS. 5A and 5C, a drive method for the actuator 10A is now described. The stator yokes 21 including twelve salient poles and coils 22 are provided on the radially outer side stator magnetic circuit 20A and the radially inner side stator magnetic circuit 29A. The adjacent coils 22 are connected to each other so as to excite the salient poles of the stator yokes 21 in directions opposite to each other, and to excite the salient poles of the opposing stator yokes 21 on the radially outer side and the radially inner side in directions opposite to each other. Thus, the four coils 22 are configured to form a set of concentrated magnetic fields among the salient poles, and sets of the four coils 22 corresponding to six phases are arranged.

Moreover, the radially outer side stator magnetic circuit 20B and the radially inner side stator magnetic circuit 29B are similarly wired so as to form six phases, and the phases separated by 180 degrees are configured to be simultaneously excited. As a result, when the stator magnetic circuits 20A and 29A at the bottom and the stator magnetic circuits 20B and 29B at the top of the drawing sheet of FIG. 5A are excited, the flange 60A receives a clockwise moment force as viewed from the front side of the drawing sheet about the point O with the electromagnetic forces. The direction of the moment force acting on the flange 60A rotates through the sequential drive of the six phases, to thereby be able to rotate the tilting direction of the swing gear 4A. This configuration is the same as that of a so-called reluctance motor, which has such a feature that a permanent magnet is not necessary and the swing part can be made lightweight and robust. Thus, this configuration is suitable for a relatively high-speed drive.

Note that, a configuration using a permanent magnet as in the first embodiment is also applicable as the configuration of the rotor magnetic circuit. Moreover, according to the second embodiment, the revolution of the swing gear 4A is regulated by the constant velocity joint 9, but the first gear 3A and the second gear 5A may be configured as fixed gears to extract the revolution of the swing gear 4A by the constant velocity joint 9.

### Third Embodiment

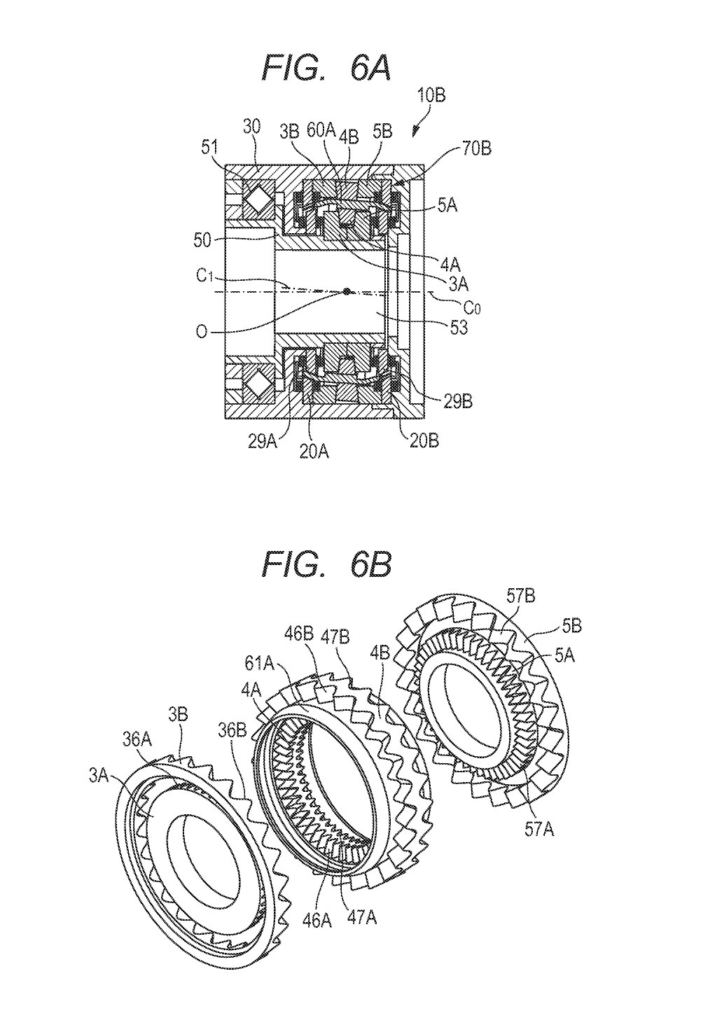

Referring to FIGS. 6A and 6B as well as FIG. 1, a robot apparatus according to a third embodiment of the present invention is now described. FIGS. 6A and 6B are diagrams illustrating an actuator according to the third embodiment. In the robot apparatus according to the third embodiment, an actuator 10B is different from the actuators 10 and 10A according to the first and second embodiments. Therefore, in the third embodiment, the point different from the first and second embodiments, namely, the actuator 10B is mainly described, and the same components as those of the first and second embodiments are denoted by the same reference symbols to omit a description thereof.

FIG. 6A is a cross sectional view of the actuator 10B, and FIG. 6B is an exploded perspective view of magnetic circuits of the actuator 10B. As illustrated in FIGS. 6A and 6B, substantially similarly to the first embodiment, the actuator 10B includes the housing (first shaft) 30, and the output shaft (second shaft) 50 supported so as to freely rotate with respect to the housing 30 through intermediation of the crossed roller bearing 51. The output shaft 50 is arranged coaxially with the housing 30. Moreover, the actuator 10B includes a drive mechanism 70B different in configuration from that of the first embodiment. The drive mechanism 70B rotationally drives the output shaft 50 with respect to the housing 30. In other words, the output shaft 50 is relatively rotated with respect to the housing 30 through the drive of the drive mechanism 70B.

Similarly to the second embodiment, the drive mechanism 70B includes the first gear 3A, the second gear 5A, and the swing gear 4A, which is the first swing gear, and further includes a third gear 3B, a fourth gear 5B, and a swing gear 4B, which is a second swing gear. These gears 3A, 5A, 3B, and 5B are arranged coaxially with the housing 30.

The first gear 3A and the second gear 5A are fixed to the outside of the output shaft 50. The first gear 3A is a face gear including the Z2 teeth 36A on one surface. The second gear 5A is a face gear including the same number Z2 of teeth 57A as that of the teeth 36A on one surface. The swing gear 4A is a face gear including the Z2+1 teeth 46A and 47A on the both surfaces. The swing gear 4A is tilted by a predetermined angle so that each of the first gear 3A and the second gear 5A and the swing gear 4A mesh with each other.

A tooth profile configured so that a large number of teeth are simultaneously in contact with each other is used also in the third embodiment, and the tilting angle and the axial position of the swing gear 4A are regulated by sandwiching the swing gear 4A between the first gear 3A and the second gear 5A. Then, the flange 60A made of a soft magnetic material is provided on the swing gear 4A, and the radially outer side stator magnetic circuits 20A and 20B and the radially inner side stator magnetic circuits 29A and 29B are provided coaxially with the housing 30.

The third embodiment is different from the second embodiment in such a point that a second differential gear mechanism is provided in place of the constant velocity joint.

In other words, the swing gear 4B is provided on an outer peripheral side of the flange 60A, and rotates coaxially and integrally with the swing gear 4A. The swing gear 4B is a face gear including Z1+1 third teeth 46B on one surface, and Z1+1 fourth teeth 47B on the other surface. The third gear 3B and the fourth gear 5B are fixed to the inside of the housing 30. The third gear 3B is a face gear including Z1 teeth 36B (teeth directed toward one side in the axial direction) on one surface. The fourth gear 5B is a face gear including the same number Z1 of teeth 57B (teeth opposed to the teeth 36B of the third gear 3B) as the teeth 36B on one surface. The swing gear 4B is tilted by a predetermined angle so that each of the third gear 3B and the fourth gear 5B and the swing gear 4B mesh with each other. In other words, the third teeth 46B of the swing gear 4B obliquely mesh with the teeth 36B of the third gear 3B, and the fourth teeth 47B of the swing gear 4B obliquely mesh with the teeth 57B of the fourth gear 5B. The tooth profile of these gears is also such a profile that a large number of teeth are simultaneously in contact with each other at the same tilting angle as the predetermined angle. Thus, the four gears 3A, 5A, 3B, and 5B smoothly mesh with the swing gears 4A and 4B under a state in which all the four gears 3A, 5A, 3B, and 5B are coaxial with the output shaft 50.

Referring to FIGS. 6A and 6B, an operation of the actuator 10B according to the third embodiment is now described. The first gear 3A and the second gear 5A of the third embodiment correspond to the second gear 5 of the first embodiment, and the third gear 3B and the fourth gear 5B correspond to the second gear 5 of the first embodiment. Thus, the first gear 3A, the second gear 5A, the third gear 3B, and the fourth gear 5B operate as a similar two-stage differential gear mechanism. Thus, an operation of rotating the direction of the moment force acting on the flange 60A to swing the swing gears 4A and 4B and therefore rotate the output shaft 50 is similar to that of the first embodiment. The resulting speed reduction ratio ranging from a medium ratio to an extremely high ratio is realized by practical numbers of teeth so that a large torque can be similarly generated.

Forces acting on respective parts due to the load torque according to the third embodiment are now described. A relationship between each of the first gear 3A and the second gear 5A and the swing gear 4A is the same as that of the second embodiment, and the torques and the forces of rotating the tilting direction cancel one another. Moreover, the same holds true for a relationship between each of the third gear 3B and the fourth gear 5B and the swing gear 4B. Thus, as in the second embodiment, the forces applied to the crossed roller bearing 51 can be suppressed to be small, thereby being capable of realizing high efficiency, low vibration, and low noise. Note that, the drive is the same as that of the second embodiment, and a description thereof is therefore omitted.

### Fourth Embodiment

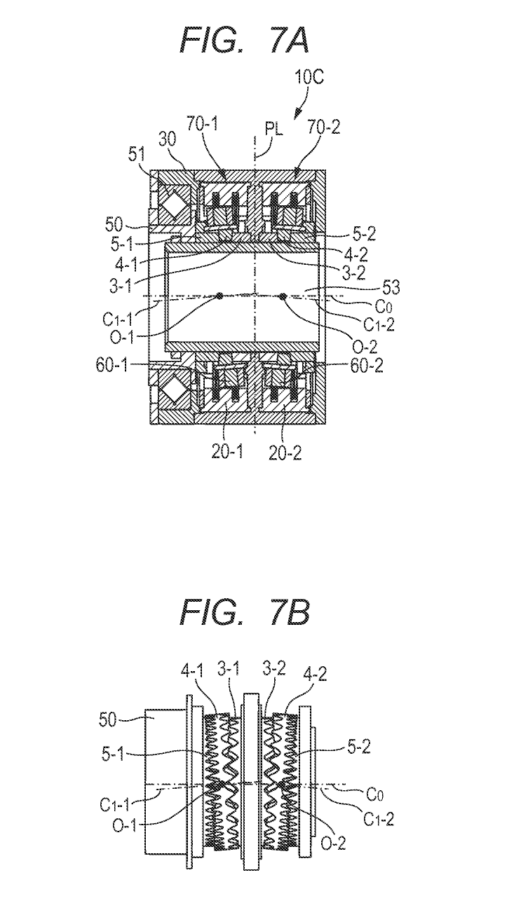

Referring to FIGS. 7A and 7B as well as FIG. 1, a robot apparatus according to a fourth embodiment of the present invention is now described. FIGS. 7A and 7B are diagrams illustrating an actuator according to the fourth embodiment. In the robot apparatus according to the fourth embodiment, an actuator 10C is different from the actuators to 10B according to the first to third embodiments. Therefore, in the fourth embodiment, the point different from the first to third embodiments, namely, the actuator 10C is mainly described, and the same components as those of the first to third embodiments are denoted by the same reference symbols to omit a description thereof.

FIG. 7A is a cross sectional view of the actuator 10C, and FIG. 7B is a side view of gears of the actuator 10C. According to the fourth embodiment, the drive mechanisms 70 of the actuator 10 according to the first embodiment are provided in pairs. A pair of drive mechanisms 70-1 and 70-2 are arranged plane symmetric across a virtual plane PL perpendicular to the axis C₀. Note that, the drive mechanism 70-1 is arranged in the same manner as the drive mechanism 70 according to the first embodiment, and the drive mechanism 70-2 is arranged plane symmetric with respect to the drive mechanism 70 according to the first embodiment.

As apparent from FIGS. 7A and 7B, the first gears 3-1 and 3-2 are integrally fixed to the housing 30 so as to be plane symmetrically with respect to the axial direction, and the stator magnetic circuits 20-1 and 20-2 are integrally fixed to the housing 30 so as to be plane symmetrically with respect to the axial direction. The second gears 5-1 and 5-2 are integrally fixed to the output shaft 50 so as to be plane symmetrically with respect to the axial direction. The swing gear 4-1 and the rotor magnetic circuit 60-1 and the swing gear 4-1 and the rotor magnetic circuit 60-2 are arranged so as to be plane symmetrically with respect to the axial direction. The swing gear 4-1 is provided so as to freely rotate about the tilting axis C₁-1 tilted about the reference point O-1 with respect to the axis C₀. The swing gear 4-2 is provided so as to freely rotate about the tilting axis C₁-2 tilted about the reference point O-2 with respect to the axis C₀.

As a result of this configuration, axial components of the forces acting from the swing gears 4-1 and 4-2 to the first gears 3-1 and 3-2 cancel each other. Moreover, axial components of the forces acting from the swing gears 4-1 and 4-2 to the second gears 5-1 and 5-2 cancel each other. On the other hand, the output torque is doubled. Therefore, the load on the crossed roller bearing is reduced, and the actuator 10C which is high in efficiency, low in vibration, and high in torque output can be realized.

Note that, the actuator may include a plurality of pairs of drive mechanisms, and the plurality of pairs of the drive mechanisms may be serially arranged in the axial direction. On this occasion, when the tilting directions are synchronized at a phase difference of 180 degrees for two pairs and at a phase difference of 120 degrees for three pairs, the balance of the acting points of the torques acting on the output shaft 50 is improved, resulting in an actuator even lower in vibration and even higher in the torque output.

### Fifth Embodiment

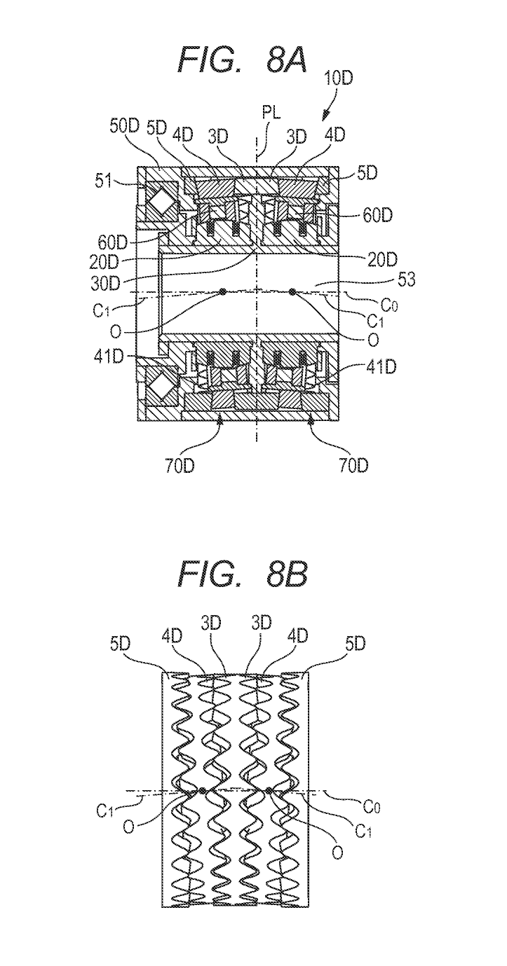

Referring to FIGS. 8A and 8B as well as FIG. 1, a robot apparatus according to a fifth embodiment of the present invention is now described. FIGS. 8A and 8B are diagrams illustrating an actuator according to the fifth embodiment. In the robot apparatus according to the fifth embodiment, an actuator 10D is different from the actuators to 10C according to the first to fourth embodiments. Therefore, in the fifth embodiment, the point different from the first to fourth embodiments, namely, the actuator 10D is mainly described, and the same components as those of the first to fourth embodiments are denoted by the same reference symbols to omit a description thereof.

FIG. 8A is a cross sectional view of the actuator 10D, and FIG. 8B is a side view of gears of the actuator 10D. The actuator 10D includes a fixed shaft 30D serving as a first shaft, and a housing 50D serving as a second shaft, which is arranged coaxially with the fixed shaft 30D and is provided so as to freely rotate with respect to the fixed shaft 30D. Moreover, the actuator 10D includes a drive mechanism 70D for rotationally driving the housing 50D with respect to the fixed shaft 30D.

The housing 50D is arranged coaxially with the fixed shaft 30D, and is supported on the fixed shaft 30D so as to freely rotate through intermediation of the crossed roller bearing 51. The drive mechanism 70D rotationally drives the housing 50D with respect to the fixed shaft 30D. In other words, the housing 50D is relatively rotated with respect to the fixed shaft 30D through the drive of the drive mechanism 70D.

In the first to fourth embodiments, the case where the first shaft is the housing 30 and the second shaft is the output shaft 50 is described, but in the fifth embodiment, the first shaft is the fixed shaft 30D, and the second shaft is the housing 50D for accommodating the drive mechanism 70D. The drive mechanism 70D is formed into an annular profile, and the fixed shaft 30D is arranged inside the drive mechanism 70D.

A hollow bore 53 is formed in the fixed shaft 30D. An outer race of the crossed roller bearing 51 is fixed to an inner surface of the housing 50D, and an inner race is fixed to an outer surface of the fixed shaft 30D.

According to the fifth embodiment, a pair of the drive mechanisms 70D are provided as in the fourth embodiment. The pair of the drive mechanisms 70D are arranged plane symmetric about the virtual plane PL perpendicular to the axis C₀. Thus, in the fifth embodiment, the same and plane symmetric components of the drive mechanisms 70D are denoted by the same reference symbols for description.

The drive mechanism 70D includes a first gear 3D, a second gear 5D, a swing gear 4D, which is a first swing gear, a stator magnetic circuit 20D, and a rotor magnetic circuit 60D. The first gear 3D, the second gear 5D, the swing gear 4D, the stator magnetic circuit 20D, and the rotor magnetic circuit 60 are formed into annular profiles. The first gear 3D, the second gear 5D, and the stator magnetic circuit 20D are arranged coaxially with the housing 50D and the fixed shaft 30D.

The stator magnetic circuit 20D is fixed to an outside of the housing 30D. A flange 41D serving as a support unit for supporting the swing gear 4D is fixed to the swing gear 4D, and the rotor magnetic circuit 60D is fixed to the flange 41D. As a result, the rotor magnetic circuit 60D is integrally fixed to the swing gear 4D through intermediation of the flange 41D. Specifically, the flange 41D in the annular profile is fixed to the outside of the rotor magnetic circuit 60D, and the swing gear 4D is fixed to the outside of the flange 41D. The swing gear 4D and the rotor magnetic circuit 60D integrated with each other are arranged outside the stator magnetic circuit 20D.

The first gear 3D, the second gear 5D, and the swing gear 4D are formed into face gears, and teeth are formed on one surface of each of the first gear 3D and the second gear 5D, and on both surfaces of the swing gear 4D. Then, the swing gear 4D is arranged between the first gear 3D and the second gear 5D. The first gears 3D are fixed to any one of the fixed shaft 30D and the housing 50D, and, according to the fifth embodiment, as illustrated in FIG. 8A, are fixed to the fixed shaft 30D. The second gears 5D are fixed to the housing 50D.

The swing gear 4D is arranged between the first gear 3D and the second gear 5D, and is provided so as to freely rotate about the tilting axis C₁ tilted with respect to the axis C₀.

As described above, the actuator 10D according to the fifth embodiment is acquired by switching the gear mechanism parts of the actuator 10C according to the fourth embodiment to the radially outer side, and the rotor magnetic circuits 60D and the stator magnetic circuits 30D to the radially inner side. The operation is the same, and hence a description thereof is omitted. The stator magnetic circuit 20D provided on the radially outer side is advantageous for heat radiation, and the gear mechanism part provided on the radially outer side withstands the maximum load torque and an impact load. Particularly when low-cost gears made of a resin are used, the gear mechanism part arranged on the radially outer side can more easily provide a large output torque.

As described above, according to the fifth embodiment, as in the first to fourth embodiments, the tilting angle and the axial position of the swing gears 4D are regulated by the first gear 3D and the second gear 5D including a large number of teeth continuously meshing, and the tilting direction is rotated by the moment force. As a result, the actuator 10D, which is compact in size, high in performance, and low in cost, can be realized.

Moreover, the load torque can be shared among a large number of teeth, and hence the actuator 10D, which is compact in size, light in weight, high in load torque, high in rigidity, and high in efficiency, can be realized. Thus, the performance of the robot can be increased by using the actuators 10D for the joints of the robot arm.

Note that, also in the actuators 10 to 10B according to the first to third embodiments, the gear mechanism part, and the rotor magnetic circuit and the stator magnetic circuit can be switched between the radially outer side and the radially inner side, and only an optimal configuration needs to be selected.

Moreover, the brushless motor with the magnet and the reluctance motor without a magnet are described in the first to fourth embodiments, but the configuration is not limited thereto. Other types of configuration can be applied. For example, a configuration of a coreless motor in which coils are provided on the rotor side so that currents are supplied via brushes may be used, and it is only necessary to apply a moment force to the swing gear with the electromagnetic force so as to rotate the tilting direction. As a result, all the gears share the load on a large number of teeth in a balanced manner, and hence the number of bearings can be reduced to minimize the number of components. Thus, an actuator compact in size, high in load capacity, high in rigidity, and high in efficiency can be realized.

Note that, the case in which the actuator is applied to the robot is described in the first to fifth embodiments, but the present invention is not limited to the robot, and is suitable for another application which requires a compact and high-torque actuator such as a drive for an electric vehicle and a belt conveyer.

Moreover, the torque can be shared among a large number of teeth in the gear mechanisms according to the first to fifth embodiments, and, for example, when high performance steel is used as the gear material, an actuator very high in performance can be realized. Note that, general steel low in cost may be used as the gear material, and a nonferrous metal, a sintered material, and a resin can also be applied.

The present invention is not limited to the embodiments described above, and can be modified in various ways within the technical idea of the present invention.

According to the present invention, the tilting angle and the axial position of the first swing gear are regulated by the first and second gears, and the stator magnetic circuit generates the rotating magnetic fields in the rotor magnetic circuit fixed to the first swing gear so that the tilting direction of the first swing gear is rotated, thereby generating the rotational output torque. As a result, the input shaft, the bearings supporting the input shaft, and the like can be omitted, and the number of components can be reduced. Moreover, the load torque can be shared among a large number of teeth, and hence a high assembly property and a high load capacity can be realized without increasing the size.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-014567, filed Jan. 29, 2014, which is hereby incorporated by reference herein in its entirety. cm What is claimed is:

1. An actuator, comprising:
a first shaft;
a second shaft arranged coaxially with the first shaft, and provided so as to freely rotate with respect to the first shaft; and
a drive mechanism for rotationally driving the second shaft with respect to the first shaft,
the drive mechanism comprising:
a first gear including teeth directed toward one side in an axial direction, and arranged coaxially with the first shaft;
a second gear including teeth opposed to the teeth of the first gear, arranged coaxially with the first shaft, and fixed to the second shaft;
a first swing gear arranged between the first gear and the second gear, and provided so as to freely rotate about a tilting axis, which is tilted with respect to an axis of the first shaft,
the first swing gear comprising:
first teeth different in number by one tooth from the teeth of the first gear, and configured to mesh with the teeth of the first gear; and
second teeth different in number by one tooth from the teeth of the second gear, and configured to mesh with the teeth of the second gear on an opposite side of a meshing portion of the first teeth with the teeth of the first gear in a radial direction and in the axial direction,
the first swing gear being configured to mesh with the first gear and the second gear at a certain tilting angle;
a rotor magnetic circuit fixed to the first swing gear; and
a stator magnetic circuit fixed to the first shaft, and configured to generate an electromagnetic force of one of attracting and repulsing the rotor magnetic circuit, to thereby swing the first swing gear.

2. An actuator according to claim 1, wherein the rotor magnetic circuit comprises a permanent magnet magnetized in a direction of the tilting axis, and arranged so as to be opposed to the stator magnetic circuit in the radial direction.

3. An actuator according to claim 1, wherein:
the rotor magnetic circuit comprises a flange including a pair of protruded pieces, which are protruded from the first swing gear toward both sides in the direction of the tilting axis, and are each made of a soft magnetic material; and
the stator magnetic circuit generates an electromagnetic force of attracting the pair of protruded pieces, to thereby swing the first swing gear.

4. An actuator according to claim 1, wherein any one of the first shaft and the second shaft comprises a housing for accommodating the drive mechanism.

5. An actuator according to claim 1, wherein the drive mechanism further comprises a support unit configured to support the first swing gear, the support unit being brought into contact with at least one of the first gear or the second gear in the radial direction.

6. An actuator according to claim 5, wherein the support unit is shaped so as to be brought into rolling contact with the at least one of the first gear or the second gear.

7. An actuator according to claim 1, wherein the first gear is fixed to the first shaft.

8. An actuator according to claim 1, wherein the first gear is fixed to the second shaft.

9. An actuator according to claim 8, wherein:
the first gear and the second gear are equal in number of teeth; and
the drive mechanism further comprises a joint mechanism configured to couple the first shaft and the first swing gear to each other.

10. An actuator according to claim 8, wherein:
the first gear and the second gear are different in number of teeth; and
the drive mechanism further comprises:
a third gear including teeth directed toward the one side in the axial direction, arranged coaxially with the first shaft, and fixed to the second shaft; and
a second swing gear including third teeth different in number by one tooth from the teeth of the third gear and configured to obliquely mesh with the teeth of the third gear, and being rotatable coaxially and integrally with the first swing gear.

11. An actuator according to claim 1, wherein the drive mechanism comprises a pair of drive mechanisms arranged plane symmetric across a plane perpendicular to the axis.

12. An actuator according to claim 11, wherein the pair of drive mechanisms comprises a plurality of pairs of drive mechanisms.

13. An articulated robot arm, comprising the actuator of claim 1, which is arranged on at least one of a plurality of joints configured to couple a plurality of links to each other.
